(19) United States
(12) Patent Application Publication
(10) Pub. No.: US 2017/0137272 A1
(43) Pub. Date: May 18, 2017

(54) LID APPLICATION

(71) Applicant: ALEX J KETH, MARVIN, NC (US)

(72) Inventor: ALEX J KETH, MARVIN, NC (US)

(21) Appl. No.: 15/351,334

(22) Filed: Nov. 14, 2016

Related U.S. Application Data
(60) Provisional application No. 62/254,554, filed on Nov. 12, 2015.

(51) Int. Cl. B67B 6/00; A47G 19/22

(52) U.S. Cl. CPC B67B 6/00; A47G 19/2272

(57) ABSTRACT

A drinking cup lid applicator comprising an applicator body, including a bottom rim, an outer surface and an inner surface, for securing a drinking cup lid onto a drinking cup without a user touching the drinking cup lid.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention relates to drinking cup lids. More specifically, the present invention relates to sanitarily applying a drinking cup lid to a drinking cup.

With the constant need to be on the move, fast food restaurants and coffee shops are selling more and more drinks. Whether the drink is a soda, coffee, or other liquid, the employee that is getting the drink for the customer must pour the drink in the drinking cup, apply the drinking cup lid to the drinking cup and give the drink to the customer.

In order to apply the drinking cup lid to the drinking cup, the employee must grab the drinking cup lid from a stack of lids using his/her fingers. Using his/her fingers, the employee then takes the lid to the drinking cup and places the lid on the drinking cup making sure the lid is securely on the drinking cup. In order to make sure that the lid is secure, the employee may move his/her finger over the edge of the lid while applying pressure so that any portion of the lid that was not securely in place is pressed into place. The employee may then give the covered drinking cup by holding the top of the drinking cup so that the customer may grab the bottom of the cup.

As you can imagine, the application of the drinking cup lid to the drinking cup provides many opportunities for the employee to touch the area of the drinking cup lid that the customer actually puts his/her mouth to in order to drink. Each employee is prone to touching hundreds of surfaces that are in varying condition. Between the handling of money, the register, the counters, machines and dispensers, as well other humans, there are multiple opportunities for the wrong kinds of germs and bacteria to spread and expose the customer to many illnesses. Again, touching the lids by the employees exasperates this potential.

Some solutions to the potential spread of germs have included separately packaging each drinking cup lid in wrap, for example so that the employee never comes into contact with the drinking cup lid. This solution, though, requires that ate customer apply the lid to the drinking cup after the employee has given the drinking cup to the customer. The potential for spilling the liquid in the drinking cup increases dramatically, which, for hot liquids, could result in serious harm to the customer and/or the employee.

Another solution includes the application of a detachable germ free cover that is able to be peeled from the drinking cup lid after the lid is placed on the drinking cup.

A method is needed for sanitarily applying a drinking cup lid to a drinking cup. This and other needs are addressed by one or more aspects of the present invention.

### SUMMARY OF THE INVENTION

The present invention includes many aspects and features. Moreover, while many aspects and features relate to, and are described in, the context of drinking cup applications, the present invention is not limited to use only in this context, as will become apparent from the following summaries and detailed descriptions of aspects, features, and one or more embodiments of the present invention.

Accordingly, one aspect of the present invention relates to a drinking cup lid applicator comprising an applicator body, including a bottom rim, an outer surface and an inner surface for securing a drinking cup lid onto a drinking cup without a user touching the drinking cup lid. The outer surface comprising a top surface and one or more slope slides, the one or more slope sides extending upwards and circumferentially from the bottom rim towards the top surface. Each of the one or more slope sides extending upward and circumferentially from a lower slope side relative to the bottom rim. The inner surface comprising an inner top surface and one or more sloped ridges, each of the one or more sloped ridges extending upwards and circumferentially towards the inner top surface and having a ridge circumference that is greater than a remaining one of the respective one or more sloped ridges that are located closer to the inner top surface relative to the bottom rim. The drinking cup lid is held within the applicator body by one or the one or more sloped ridges having a ridge circumference that is similar to a circumference of a top of the drinking cup lid.

Another aspect of the present invention relates to a method for sanitarily placing a drinking cup lid on a drinking cup comprising the steps of retrieving a lid applicator, placing the lid applicator over a top of the drinking cup lid, wherein the drinking cup lid is secured within the lid applicator, moving the drinking cup lid to the drinking cup using the lid applicator, placing the drinking cup lid onto the drinking cup using the lid applicator, and removing the lid applicator from the drinking cup lid, wherein the drinking cup lid remains on the drinking cup.

In addition to the aforementioned aspects and features of the present invention. it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is an example perspective view illustration of an implementation of a disclosed drinking cup lid applicator in accordance with the present invention;

FIG. 2 is an example top view illustration of the drinking cup lid applicator of FIG. 1;

FIG. 3 is an example side view illustration of the drinking cup lid applicator of FIG. 1;

FIG. 4 is an example bottom perspective view of the drinking cup lid applicator of FIG. 1;

FIG. 5 is an example bottom view illustration of the drinking cup lid applicator of FIG. 1;

FIG. 6 is an example flow diagram of an implementation for sanitarily applying a drinking cup lid using the disclosed lid applicator in accordance with the present invention;

FIGS. 7 and 8 are example illustrations of a user placing an implementation of a sanitary applicator onto a drinking cup lid;

FIG. 9 is an example illustration of the drinking cup lid applicator shown in FIG. 7, as the drinking cup lid, using the lid applicator, is being placed on the drinking cup by the user;

FIG. 10 is an example illustration of the drinking cup applicator shown in FIG. 7 as the user is removing the applicator from the cup lid; and

FIG. 11 is an example illustration of the drinking cup including the cup lid securely placed thereon.

### DETAILED DESCRIPTION

Referring now to the drawings, one or more preferred embodiments of the present invention are next described. The following description of one or more preferred embodiments is merely exemplary in nature and is in no way intended to limit the invention, its implementations, or uses.

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

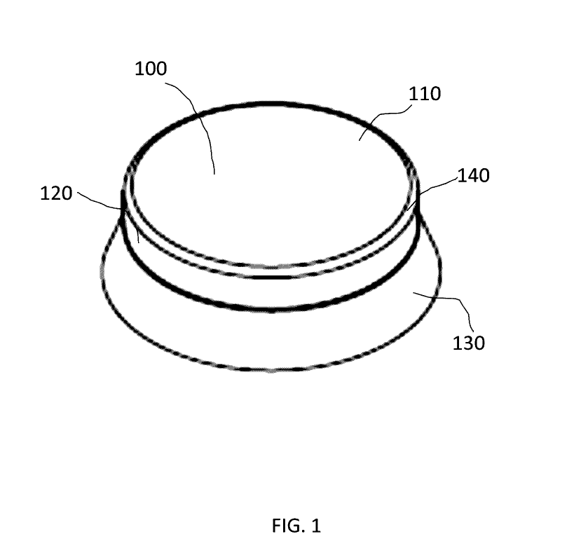

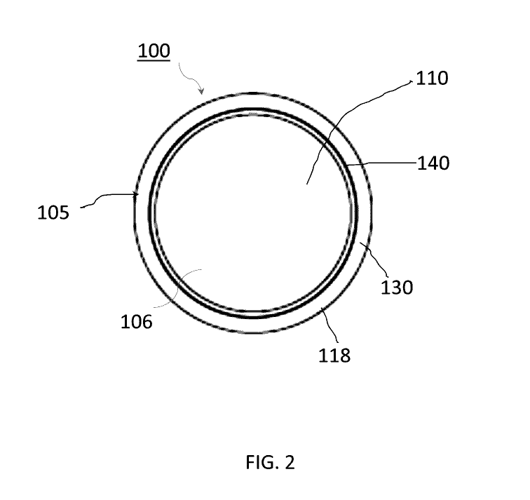

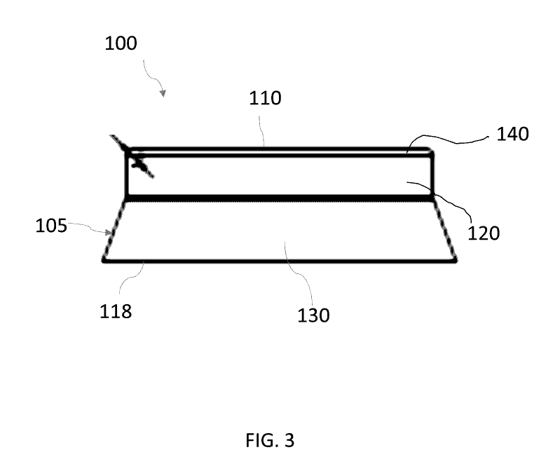

FIG. 1 is an example perspective view illustration of an implementation of a disclosed drinking cup lid applicator 100. FIGS. 2 and 3 are example top view and side view illustrations, respectively, of the drinking cup applicator 100 shown in FIG. 1. Referring to FIG. 1, the lid applicator 100 comprises an applicator body 105. The applicator body 105 may be made from any type of material, i.e., ceramic, polymer, glass, metal, wood, and composites. The applicator body 105 includes an outer surface 106 and an inner surface (not shown). The outer surface 106 and the inner surface may be made from the same material, e.g., rubber, or different types of materials, for example, the outer surface may be made from PVC and the inner surface may be made of rubber. In a preferred implementation, the inner surface and the outer surface are made from the same material, for example, rubber.

The outer surface 106 includes a top surface 110, a bottom rim 118, and one or more outer slope sides 140, 120, 130 that extend upward, inward and circumferentially from the bottom rim 118 to the top surface 110. In a preferred embodiment, the circumference of each slope side decreases as the slope side extends upward, such that the circumference of the slope side extending to the top surface is the equal to the circumference of the top surface.

In an implementation, the slope side 130 extends upward and circumferentially from the bottom rim 118 to the outer slope side 120. The outer slope side 120 extends up extends upward and circumferentially from the outer slope side 130 to the outer slope side 140. The outer slope side 140 extends upward and circumferentially from the outer slope side 120 to the top surface 110.

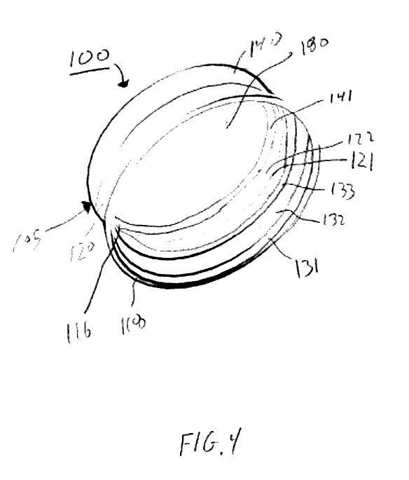

FIG. 4 is an example bottom perspective view of the lid applicator 100 shown in FIG. 1. In an implementation, the inner surface 116 includes an inner top surface 180 and one or more sloped ridges 121, 122, 131, 132, 133, 141. The sloped ridges 121, 122, 131, 132, 133, 141 preferably allow the lid applicator 100 to accommodate drinking cup lids of differing sizes and designs (to be disclosed hereinafter). The inner surface 116 slopes inward toward the inner top surface 180 and extends upward and circumferentially from the bottom rim 118.

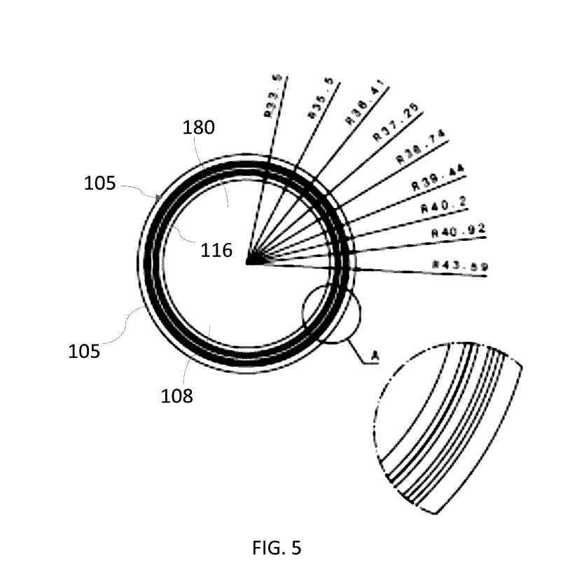

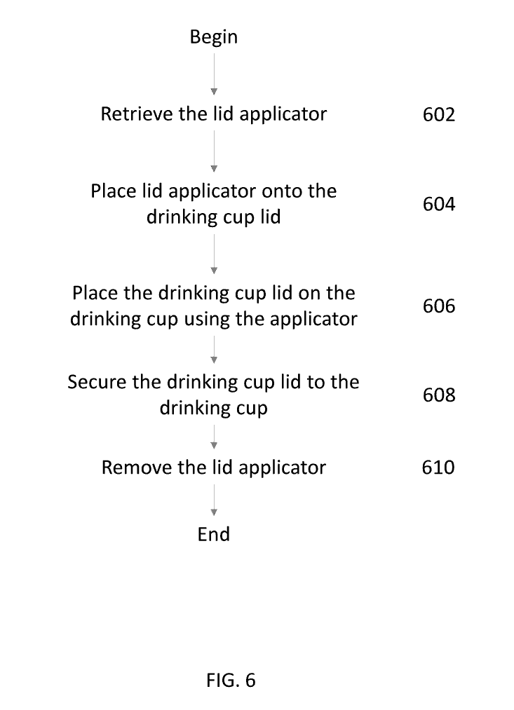

Each sloped ridge 121, 122, 131, 132, 133, 141 extends upward and inward circumferentially from the sloped ridge below, such that the sloped ridge below a respective sloped ridge has a ridge circumference that is greater than the respective sloped ridge's ridge circumference. For example, sloped ridge 131 extends inward from the bottom rim 118 to sloped ridge 132, and therefore, the ridge circumference of sloped ridge 131 is greater than the ridge circumference of sloped ridge 132, which is illustratively exemplified by the radii shown in the blown-up portion of FIG. 5. FIG. 5 is an example bottom view illustration of the drinking cup lid applicator 100 of FIG. 1.

As disclosed, the ridge circumference of each sloped ridge accommodates the top of a drinking cup lid having a similar circumference. For example, the disclosed lid applicator may be placed on top of a drinking cup lid. Based on the circumference of the drinking cup lid, the lid applicator will fit securely around the top of the drinking cup lid at the slope ridge having the same or similar circumference. It is preferable that the drinking cup lid be securely within the lid applicator such that when the drinking cup lid is moved using the lid applicator, the drinking cup lid remains within the lid applicator until the drinking cup lid is placed on a drinking cup and the lid applicator removed therefrom.

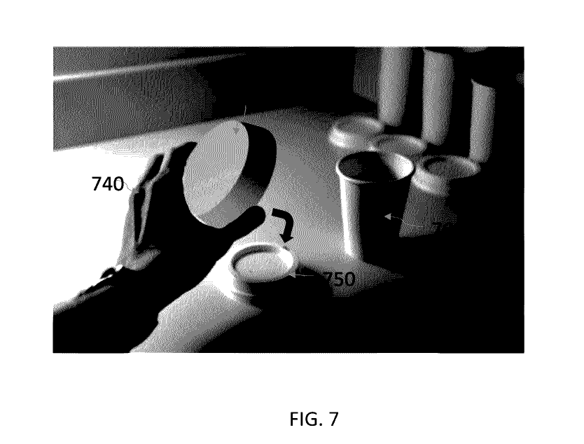

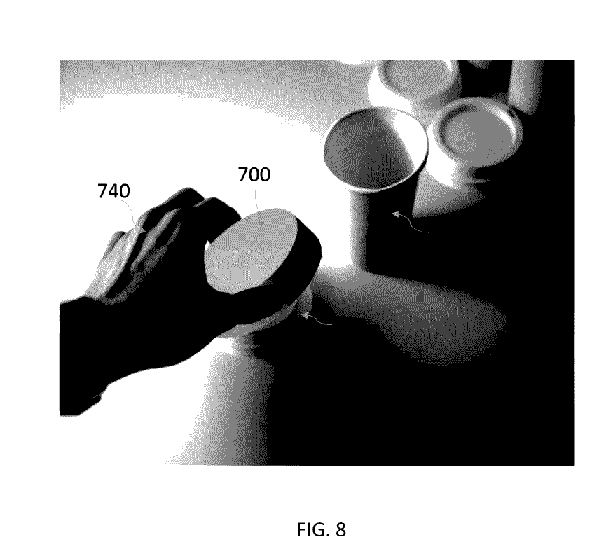

An example flow diagram of an implementation for sanitarily applying a drinking cup lid using the disclosed lid applicator is shown in FIG. 4. A drinking cup applicator is stored in a location that limits exposure of the inner surface to bacteria. A user/employee may retrieve the applicator from the storage place by grabbing the applicator on the outer surface (600). The applicator is placed over the drinking cup lid such that the inner surface of the applicator surrounds at least the top portion of the drinking cup lid (602). FIGS. 7 and 8 is an example illustration of a user 740 placing an implementation of a sanitary applicator 700 onto a drinking cup lid 750. With the applicator over the cup lid, the user again grips the outer surface of the applicator and lifts the cup lid using the applicator (604).

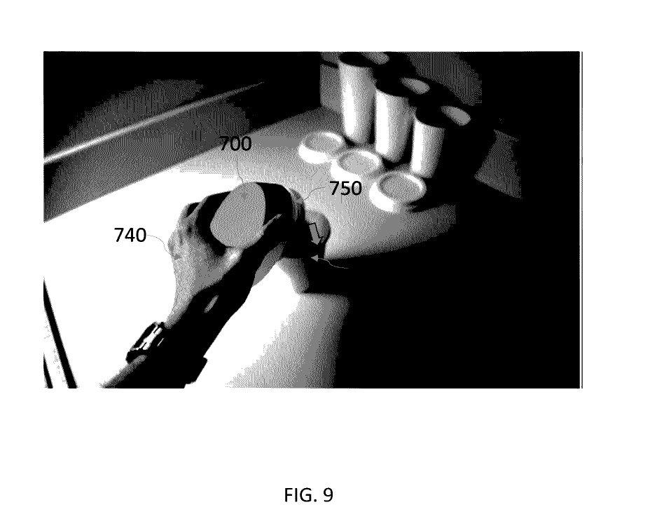

With the beverage in the drinking cup, the user may place the cup lid on the drinking cup using the applicator (606), and presses the cup lid using the applicator on the drinking cup to ensure that the cup lid is securely on the drinking cup (608). FIG. 9 is an example illustration of the applicator 700 shown in FIG. 7 as the cup lid 750, using the applicator 700, is being placed on the drinking cup 760 by the user 740.

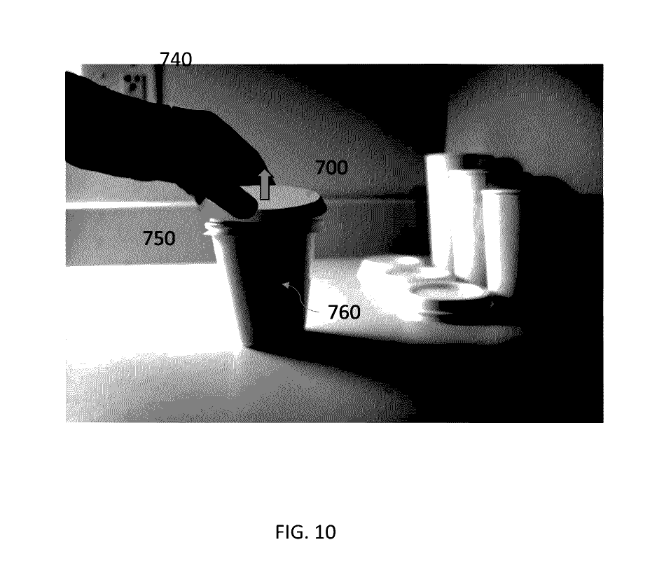

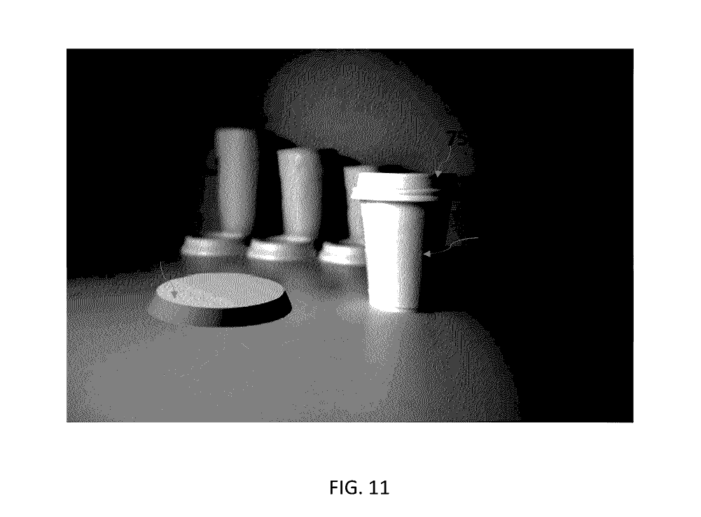

Once the cup lid is securely in place on the drinking cup, the user removes the applicator from the cup lid (610) and places the applicator back where the applicator is stored (612). FIG. 10 is an example illustration of applicator 700 shown in FIG. 7 as the user 740 is removing the applicator 700 from the cup lid 750 when the cup lid 750 is securely in place on the drinking cup 760. FIG. 11 is an example illustration of the drinking cup 760 including the cup lid 750 securely placed thereon.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A drinking cup lid applicator comprising:
an applicator body, including a bottom rim, an outer surface and an inner surface for securing a drinking cup lid onto a drinking cup without a user touching the drinking cup lid;
the outer surface comprising a top surface and one or more slope slides, the one or more slope sides extending upwards and circumferentially from the bottom rim towards the top surface,
each of the one or more slope sides extending upward and circumferentially from a lower slope side relative to the bottom rim, and
the inner surface comprising an inner top surface and one or more sloped ridges,
each of the one or more sloped ridges extending upwards and circumferentially towards the inner top surface and having a ridge circumference that is greater than a remaining one of the respective one or more sloped ridges that are located closer to the inner top surface relative to the bottom rim,
wherein the drinking cup lid is held within the applicator body by one or the one or more sloped ridges having a ridge circumference that is similar to a circumference of a top of the drinking cup lid.

2. A method for sanitarily placing a drinking cup lid on a drinking cup comprising the steps:
retrieving a lid applicator;
placing the lid applicator over a top of the drinking cup lid, wherein the drinking cup lid is secured within lid applicator;
moving the drinking cup lid to the drinking cup using the lid applicator;
placing the drinking cup lid onto the drinking cup using the lid applicator; and
removing the lid applicator from the drinking cup lid, wherein the drinking cup lid remains on the drinking cup.
